(19) United States
(12) Patent Application Publication
(10) Pub. No.: US 2022/0206408 A1
(43) Pub. Date: Jun. 30, 2022

(54) CONCENTRATING AN INK COMPOSITION

(71) Applicant: Hewlett-Packard Development Company, L.P., Spring, TX (US)

(72) Inventors: Doron SCHLUMM, Nes Ziona (IL); Mark SANDLER, Nes Ziona (IL); Assaf PINES, Nes Ziona (IL); Gilad NOY, Nes Ziona (IL); Orel Yosef MIZRAHI, Nes Ziona (IL)

(73) Assignee: Hewlett-Packard Development Company, L.P., Spring, TX (US)

(21) Appl. No.: 17/429,649

(22) PCT Filed: Jul. 26, 2019
(86) PCT No.: PCT/US2019/043742

§ 371 Date: Aug. 10, 2021

(51) Int. Cl. G03G 9/135; G03G 9/125; G03G 9/08; G03G 9/087

(52) U.S. Cl. CPC G03G 9/135; G03G 9/125; G03G 9/087; G03G 9/0827; G03G 9/0823

(57) ABSTRACT

Herein is disclosed a method for concentrating a liquid electrostatic ink composition, the method comprising replacing a first liquid carrier in a liquid electrostatic ink composition with a second liquid carrier, wherein the liquid electrostatic ink composition comprises chargeable toner particles dispersed in the first liquid carrier; and removing the second liquid carrier to produce a concentrated liquid electrostatic ink composition, wherein the second liquid carrier has a boiling point below 100° C. and wherein the second liquid carrier has a lower boiling point than the first liquid carrier. Also disclosed herein is a concentrated liquid electrostatic ink composition producible according to the method.

### BACKGROUND

In general, electrostatic printing processes involve creating an image on a photoconductive surface, applying an ink having charged particles to the photoconductive surface, such that they selectively bind to the image, and then transferring the charged particles in the form of the image to a substrate.

The photoconductive surface is typically on a cylinder and is often termed a photo imaging plate (PIP). The photoconductive surface is selectively charged with a latent electrostatic image having image and background areas with different potentials. For example, an electrostatic ink composition comprising charged toner particles in a liquid carrier can be brought into contact with the selectively charged photoconductive surface. The charged toner particles adhere to the image areas of the latent image while the background areas remain clean. The image is then transferred to a print substrate (e.g., paper) directly or, more commonly, by being first transferred to an intermediate transfer member, which can be a soft swelling blanket, and then to the substrate.

### BRIEF DESCRIPTION OF THE FIGURES

FIG. 1 is a photograph (taken at a magnification of 480 pix/mm) of a concentrated liquid electrostatic ink composition at 99 wt. % non-volatile solids.

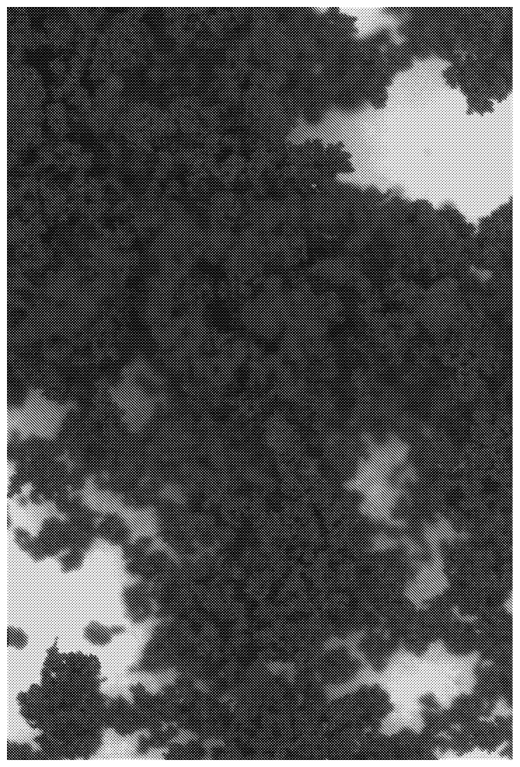

### DETAILED DESCRIPTION

Before more detail is given about the present disclosure, it is to be understood that this disclosure is not limited to the particular process steps and materials disclosed herein because such process steps and materials may vary somewhat. It is also to be understood that the terminology used herein is used for the purpose of describing particular examples only. The terms are not intended to be limiting because the scope of the present disclosure is intended to be limited only by the appended claims and equivalents thereof.

It is noted that, as used in this specification and the appended claims, the singular forms “a”, “an”, and “the” include plural referents unless the context clearly dictates otherwise.

As used herein, “copolymer” refers to a polymer that is polymerized from at least two monomers.

A certain monomer may be described herein as constituting a certain weight percentage of a polymer. This indicates that the repeating units formed from the said monomer in the polymer constitute said weight percentage of the polymer.

If a standard test is mentioned herein, unless otherwise stated, the version of the test to be referred to is the most recent at the time of filing this patent application.

As used herein, “electrophotographic ink composition” or “electrostatic ink composition” generally refers to an ink composition that is typically suitable for use in an electrophotographic printing process, sometimes termed an electrostatic printing process. The electrophotographic ink composition may include chargeable particles of the resin and the pigment dispersed in a liquid carrier, which may be as described herein.

As used herein, “electrophotographic printing” or “electrostatic printing” generally refers to the process that provides an image that is transferred from a photoimaging plate either directly, or indirectly via an intermediate transfer member, to a print substrate. As such, the image is not substantially absorbed into the photoimaging plate on which it is applied. Additionally, “electrophotographic printers”, “electrophotographic printing apparatus”, “electrostatic printing apparatus” or “electrostatic printers” generally refer to those printers capable of performing electrophotographic printing or electrostatic printing, as described above. “Liquid electrophotographic printing” is a specific type of electrophotographic printing where a liquid ink is employed in the electrophotographic process rather than a powder toner. An electrostatic printing process may involve subjecting the electrostatic ink composition to an electric field, e.g., an electric field having a field gradient of 1000 V/mm or more, or in some examples 1500 V/mm or more.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Unless otherwise stated, viscosity was measured using an AR-2000 model Rheometer from TAI (Thermal Analysis Instruments). The rheometer is used as a viscometer, by applying shear forces on the testing sample between two parallel plates. The sample is loaded between parallel plates at a known gap with an oscillatory (sinusoidal) shear profile of from 0.01 to 1,000 s-1 at a temperature of 25° C.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 wt. % to about 5 wt. %” should be interpreted to include not only the explicitly recited values of about 1 wt. % to about 5 wt. %, but also include individual values and subranges within the indicated range. Thus, included in this numerical range are individual values such as 2, 3.5, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

As used herein, the boiling point is measured at standard pressure (1 atmosphere).

Unless otherwise stated, any feature described herein can be combined with any aspect or any other feature described herein.

In an aspect, there is provided a method for concentrating a liquid electrostatic ink composition. The method for concentrating a liquid electrostatic ink composition may comprise:
replacing a first liquid carrier in a liquid electrostatic ink composition with a second liquid carrier, wherein the liquid electrostatic ink composition comprises chargeable toner particles dispersed in the first liquid carrier; and
removing the second liquid carrier to produce a concentrated liquid electrostatic ink composition,
wherein the second liquid carrier has a boiling point below 100° C. and wherein the second liquid carrier has a lower boiling point than the first liquid carrier.

In another aspect, there is provided a concentrated liquid electrostatic ink composition. The concentrated liquid electrostatic ink composition may comprise:
chargeable toner particles comprising a resin; and
a liquid present in an amount of no more than 500 ppm, wherein the liquid has a boiling point below 100° C.

In a further aspect, there is provided a print ready liquid electrostatic ink composition.

The print ready liquid electrostatic ink composition may comprise:
chargeable toner particles comprising a resin;
a first liquid carrier; and
a second liquid carrier, wherein the second liquid carrier has a boiling point below 100° C.; and wherein the second liquid carrier has a lower boiling point than the first liquid carrier.

Currently, many liquid electrostatic ink compositions are supplied at 22 to 42 wt. % non-volatile solids. Improvements in recycling of liquid carrier on printing presses have resulted in excess liquid carrier being disposed of after printing.

To reduce this supply of surplus liquid carrier as part of liquid electrostatic ink compositions, a method for concentrating liquid electrostatic ink compositions has been sought that provides higher non-volatile solids content without detrimentally affecting the particle size distribution of the chargeable particles in the ink. The method for concentrating a liquid electrostatic ink composition described herein has been found to produce concentrated liquid electrostatic ink compositions that largely maintain the particle size distribution achieved for the liquid electrostatic ink composition before it was concentrated. After re-dilution to form the print ready liquid electrostatic ink composition, this particle size distribution was still largely maintained. In addition, the physical properties of the liquid electrostatic ink composition were also largely maintained after re-dilution to form the print ready liquid electrostatic ink composition.

Method for Concentrating a Liquid Electrostatic Ink Composition

In an aspect, there is provided a method for concentrating a liquid electrostatic ink composition. The method for concentrating a liquid electrostatic ink composition may comprise: replacing a first liquid carrier in a liquid electrostatic ink composition with a second liquid carrier, wherein the liquid electrostatic ink composition comprises chargeable toner particles dispersed in the first liquid carrier; and removing the second liquid carrier to produce a concentrated liquid electrostatic ink composition, wherein the second liquid carrier has a boiling point below 100° C. and wherein the second liquid carrier has a lower boiling point than the first liquid carrier.

In some examples, at least 50 wt. % of the first liquid carrier is replaced by the second liquid carrier. In some examples, at least 55 wt. % of the first liquid carrier is replaced by the second liquid carrier, for example, at least 60 wt. %, at least 65 wt. %, at least 70 wt. %, at least 75 wt. %, at least 80 wt. %, at least 85 wt. %, at least 90 wt. %, at least 95 wt. %, at least 95 wt. %, at least 96 wt. %, at least 97 wt. %, at least 98 wt. %, at least 99 wt. % or 100 wt. % of the first liquid carrier is replaced by the second liquid carrier. In some examples, 50 wt. % to 95 wt. % of the first liquid carrier is replaced by the second liquid carrier, for example, 55 wt. % to 96 wt. %, 60 wt. % to 97 wt. %, 65 wt. % to 98 wt. %, 70 wt. % to 99 wt. %, 75 wt. % to 100 wt. %, 80 wt. % to 100 wt. %, 85 wt. % to 100 wt. %, 90 wt. % to 100 wt. %, 95 wt. % to 100 wt. %, 50 wt. % to 95 wt. %, 55 wt. % to 96 wt. %, 60 wt. % to 97 wt. %, 65 wt. % to 98 wt. %, 70 wt. % to 99 wt. %, 75 wt. % to 100 wt. %, 80 wt. % to 100 wt. %, 85 wt. % to 100 wt. %, 90 wt. % to 100 wt. %, or 95 wt. % to 100 wt. %, 96 wt. % to 99 wt. %, 97 wt. % to 100 wt. %, 98 wt. % to 100 wt. %, or 99 wt. % to 100 wt. % of the first liquid carrier is replaced by the second liquid carrier.

In some examples, the first liquid carrier in the liquid electrostatic ink composition is replaced with a second liquid carrier by adding the second liquid carrier to the liquid electrostatic ink composition and removing a major part of the liquid (comprising a mixture of the first liquid carrier and the second liquid carrier) from the liquid electrostatic ink composition.

In some examples, the weight of second liquid carrier added to the liquid electrostatic ink composition is at least one quarter of the weight of the initial liquid electrostatic ink composition, for example, at least one third of the weight of the initial liquid electrostatic ink composition, at least one half of the weight of the initial liquid electrostatic ink composition, at least the same weight as the initial liquid electrostatic ink composition. In some examples, the weight of second liquid carrier added to the liquid electrostatic ink composition is at most 50 times the weight of the initial liquid electrostatic ink composition, for example, at most 25 times the weight of the initial liquid electrostatic ink composition, at most 20 times, at most 15 times, at most 10 times, at most 8 times, at most 6 times, at most 5 times, at most 4 times, at most 3 times, at most twice the weight of the initial liquid electrostatic ink composition. In some examples, the weight of second liquid carrier added to the liquid electrostatic ink composition is from one quarter to 50 times the weight of the initial liquid electrostatic ink composition, for example, one third to 25 times, one half to 20 times, 1 to 10 times, ¼ to 5 times, ⅓ to 4 times, ½ to 3 times the weight of the initial liquid electrostatic ink composition. In some examples, all of the second liquid carrier is added to the liquid electrostatic ink composition at once. In some examples, the addition of the second liquid carrier to the liquid electrostatic ink composition and the removal of a major part of the liquid occurs repeatedly such that the weight of the second liquid carrier added is split over several additions of second liquid carrier.

In some examples, the method for concentrating a liquid electrostatic ink composition may comprise adding a second liquid carrier to the liquid electrostatic ink composition and removing a major part of the liquid from the liquid electrostatic ink composition, wherein the removed liquid comprises a mixture of the first liquid carrier and the second liquid carrier; and removing the second liquid carrier to produce a concentrated liquid electrostatic ink composition, wherein the second liquid carrier has a boiling point below 100° C. and wherein the second liquid carrier has a lower boiling point than the first liquid carrier.

In some examples, the major part of the liquid is removed from the liquid electrostatic ink composition by a separation technique. In some examples, the separation technique may be filtration, for example, filtration under vacuum. In some examples, the major part of the liquid is removed from the liquid electrostatic ink composition by allowing the solids in the composition to settle and removing the liquid from the top, for example, by syringe. In some examples, the major part of the liquid is removed from the liquid electrostatic ink composition by centrifugation. In some examples, the major part of the liquid is removed by charging the solids of the liquid electrostatic ink composition and passing the ink composition between two surfaces with a potential applied between the two surfaces such that the charged solids of the liquid electrostatic ink composition are attracted to one surface and a major part of the liquid is removed on the second surface.

In some examples, replacing a first liquid carrier in a liquid electrostatic ink composition with a second liquid carrier comprises passing a second liquid carrier through the liquid electrostatic ink composition, wherein the second liquid carrier dissolves the first liquid carrier, removing the first liquid carrier from the liquid electrostatic ink composition.

In some examples, the first liquid carrier in the liquid electrostatic ink composition is replaced with a second liquid carrier by continuous filtration. In some examples, the continuous filtration is performed by continuously adding the second liquid carrier to the liquid electrostatic ink composition while simultaneously removing the liquid (comprising a mixture of the first liquid carrier and the second liquid carrier) from the liquid electrostatic ink composition at, for example, approximately the same rate. In some examples, the concentration of the non-volatile solids in the liquid electrostatic ink composition is maintained throughout the continuous filtration. In some examples, the continuous filtration initially dilutes the liquid electrostatic ink composition before maintaining the concentration of non-volatile solids at this (lower) concentration throughout the rest of the continuous filtration process. In some examples, the amount of non-volatile solids in the liquid electrostatic ink composition may be maintained at (or reduced to and then maintained at) 20 wt. % or less non-volatile solids throughout the continuous filtration, for example, 15 wt. % or less non-volatile solids, or about 10 wt. % non-volatile solids throughout the continuous filtration.

In some examples, the method for concentrating a liquid electrostatic ink composition may comprise contacting the second liquid carrier with the liquid electrostatic ink composition and filtering the composition to remove a major part of the liquid from the liquid electrostatic ink composition, wherein the removed liquid comprises a mixture of the first liquid carrier and the second liquid carrier; and removing the second liquid carrier to produce a concentrated liquid electrostatic ink composition, wherein the second liquid carrier has a boiling point below 100° C. and wherein the second liquid carrier has a lower boiling point than the first liquid carrier.

In some examples, removing a major part of the liquid from the liquid electrostatic ink composition produces a composition comprising chargeable particles having a liquid absorbed therein. In some examples, the absorbed liquid comprises the second liquid carrier. In some examples, the absorbed liquid comprises a mixture of the first liquid carrier and the second liquid carrier. In some examples, the absorbed liquid comprises a mixture of the first liquid carrier and the second liquid carrier, wherein the mixture comprises more of the second liquid carrier than the first liquid carrier. In some examples, removing a major part of the liquid from the liquid electrostatic ink composition comprises removing over 50 wt. % of the liquid from the liquid electrostatic ink composition. In some examples, removing a major part of the liquid from the liquid electrostatic ink composition comprises removing up to 90 wt. % of the liquid from the liquid electrostatic ink composition. In some examples, removing a major part of the liquid from the liquid electrostatic ink composition comprises removing as much of the liquid as possible without removing any of the non-volatile solids. In some examples, the major part of the liquid is removed from the liquid electrostatic ink composition by syringe until only a thin layer, for example, a layer with a thickness of up to 10 mm, remains above the non-volatile solids that have settled.

In some examples, after the second liquid carrier is added to the liquid electrostatic ink composition, mixing is performed before the major part of the liquid is removed. In some examples, mixing is performed for 1 hour or more, for example, 2 hours or more, 3 hours or more, 4 hours or more, 5 hours or more, 6 hours or more, 7 hours or more, 8 hours or more, 9 hours or more, 10 hours or more, 11 hours or more, 12 hours or more, 13 hours or more, 14 hours or more, 15 hours or more, 16 hours or more, 17 hours or more, 18 hours or more, 19 hours or more, 20 hours or more, 21 hours or more, 22 hours or more, 23 hours or more, or 24 hours or more. In some examples, mixing is performed for 24 hours or less, for example, 23 hours or less, 22 hours or less, 21 hours or less, 20 hours or less, 19 hours or less, 18 hours or less, 17 hours or less, 16 hours or less, 15 hours or less, 14 hours or less, 13 hours or less, 12 hours or less, 11 hours or less, 10 hours or less, 9 hours or less, 8 hours or less, 7 hours or less, 6 hours or less, 5 hours or less, 4 hours or less, 3 hours or less, 2 hours or less, or 1 hour or less. In some examples, mixing is performed for 1 hours to 24 hours, 2 hours to 23 hours, 3 hours to 22 hours, 4 hours to 21 hours, 5 hours to 20 hours, 6 hours to 19 hours, 7 hours to 18 hours, 8 hours to 17 hours, 9 hours to 16 hours, 10 hours to 15 hours, 11 hours to 14 hours, or 12 hours to 13 hours.

In some examples, after the first liquid carrier is replaced in the liquid electrostatic ink composition with the second liquid carrier, the second liquid carrier is removed to produce a concentrated liquid electrostatic ink composition. In some examples, removing the second liquid carrier comprises evaporating the second liquid carrier, spray drying the liquid electrostatic ink composition or filtering the liquid electrostatic ink composition. In some examples, removing the second liquid carrier comprises evaporating the second liquid carrier. In some examples, removing the second liquid carrier comprises spray drying the liquid electrostatic ink composition. In some examples, removing the second liquid carrier comprises filtering the liquid electrostatic ink composition.

In some examples, the second liquid carrier is evaporated at room temperature and pressure. In some examples, the second liquid carrier is evaporated under reduced pressure. In some examples, the second liquid carrier is evaporated under heating. In some examples, the second liquid carrier is evaporated under heating and under reduced pressure.

In some examples, the second liquid carrier is removed by filtration under reduced pressure.

In some examples, the spray drying is spray drying with hot gas. In some examples, the spray drying is spray drying with cold gas. In some examples, the gas is air, for example, heated air.

In some examples, the second liquid carrier is evaporated naturally, that is, at room temperature and pressure by leaving the liquid electrostatic ink composition open to the atmosphere for a period of time, for example, 5 hours or more, 6 hours or more, 7 hours or more, 8 hours or more, 9 hours or more, 10 hours or more, 11 hours or more, 12 hours or more, 13 hours or more, 14 hours or more, 15 hours or more, 16 hours or more, 17 hours or more, 18 hours or more, 19 hours or more, 20 hours or more, 21 hours or more, 22 hours or more, 23 hours or more, or 24 hours or more. In some examples, the second liquid carrier is evaporated at room temperature and pressure by leaving the liquid electrostatic ink composition open to the atmosphere for a period of time, for example, 24 hours or less, 23 hours or less, 22 hours or less, 21 hours or less, 20 hours or less, 19 hours or less, 18 hours or less, 17 hours or less, 16 hours or less, 15 hours or less, 14 hours or less, 13 hours or less, 12 hours or less, 11 hours or less, 10 hours or less, 9 hours or less, 8 hours or less, 7 hours or less, 6 hours or less, or 5 hours or less. In some examples, the second liquid carrier is evaporated at room temperature and pressure by leaving the liquid electrostatic ink composition open to the atmosphere for a period of time, for example, 5 hours to 24 hours, 6 hours to 23 hours, 7 hours to 22 hours, 8 hours to 21 hours, 9 hours to 20 hours, 10 hours to 19 hours, 11 hours to 18 hours, 12 hours to 17 hours, 12 hours to 16 hours, 12 hours to 15 hours, 12 hours to 14 hours, or 12 hours to 13 hours.

In some examples, the evaporation occurs under a reduced pressure of 100 kPa or less, for example, 90 kPa or less, 80 kPa or less, 70 kPa or less, 60 kPa or less, 50 kPa or less, 40 kPa or less, 30 kPa or less, 20 kPa or less, or 10 kPa or less. In some examples, the evaporation under reduced pressure is performed at a pressure of 1 kPa to 100 kPa, for example, 2 kPa to 90 kPa, 3 kPa to 80 kPa, 4 kPa to 70 kPa, 5 kPa to 60 kPa, 6 kPa to 50 kPa, 7 kPa to 40 kPa, 8 kPa to 30 kPa, 9 kPa to 20 kPa, or 10 kPa to 100 kPa.

In some examples, the evaporation occurs under heating to a temperature below the temperature of a phase change of the chargeable particles. In some examples, the evaporation occurs under heating to a temperature of 100° C. or less, for example, 90° C. or less, 85° C. or less, 80° C. or less, 75° C. or less, 70° C. or less, 65° C. or less, 60° C. or less, 55° C. or less, 50° C. or less, 45° C. or less, 40° C. or less, 35° C. or less, or 30° C. or less. In some examples, the evaporation occurs under heating to a temperature of 30° C. or more, 35° C. or more, 40° C. or more, 45° C. or more, 50° C. or more, 55° C. or more, 60° C. or more, 65° C. or more, 70° C. or more, 75° C. or more, 80° C. or more, 85° C. or more, 90° C. or more, 95° C. or more, or 100° C. or more. In some examples, the evaporation occurs under heating to a temperature of 30° C. to 100° C., 40° C. to 90° C., 50° C. to 80° C., 50° C. to 70° C., or 50° C. to 60° C.

In some examples, the concentrated liquid electrostatic ink composition comprises at least 70 wt. % non-volatile solids, for example, at least at least 75 wt. %, at least 80 wt. %, at least 85 wt. %, at least 90 wt. %, at least 95 wt. %, at least 96 wt. %, at least 97 wt. %, at least 98 wt. %, at least 99 wt. % or 100 wt. % non-volatile solids. In some examples, the concentrated liquid electrostatic ink composition comprises 70 wt. % to 100 wt. % non-volatile solids, 75 wt. % to 99 wt. %, 80 wt. % to 98 wt. %, 85 wt. % to 97 wt. %, 90 wt. % to 96 wt. %, 90 wt. % to 95 wt. %, 90 wt. % to 94 wt. %, 90 wt. % to 93 wt. %, 90 wt. % to 92 wt. %, or 90 wt. % to 91 wt. % non-volatile solids.

In some examples, the method for concentrating the liquid electrostatic ink composition may be carried out repeatedly. In some examples, the method for concentrating the liquid electrostatic ink composition may be carried out repeatedly, resulting in higher non-volatile solids contents of the concentrated liquid electrostatic ink composition for each iteration. In some examples, the method for concentrating the liquid electrostatic ink composition is performed once. In some examples, the method for concentrating the liquid electrostatic ink is performed up to 10 times, for example, up to 9 times, up to 8 times, up to 7 times, up to 6 times, up to 5 times, up to 4 times, up to 3 times or up to 2 times. In some examples, the method for concentrating the liquid electrostatic ink composition is performed 1 to 10 times, for example, 1 to 9 times, 1 to 8 times, 2 to 7 times, 3 to 6 times or 4 to 5 times.

In some examples, replacing a first liquid carrier in a liquid electrostatic ink composition with a second liquid carrier may comprise adding the second liquid carrier to the liquid electrostatic ink composition; removing a major part of the liquid from the liquid electrostatic ink composition; and repeating this addition and removal process. In some examples, each iteration of adding second liquid carrier and removing a major part of the liquid replaces an increased proportion of the initial amount of the first liquid carrier with the second liquid carrier. In some examples, the addition and removal process is performed one or more times, for example, up to 10 times, up to 9 times, up to 8 times, up to 7 times, up to 6 times, up to 5 times, up to 4 times, up to 3 times or up to 2 times. In some examples, the addition and removal process is performed 1 to 10 times, for example, 1 to 9 times, 1 to 8 times, 2 to 7 times, 3 to 6 times or 4 to 5 times.

In some examples, replacing the first liquid carrier in a liquid electrostatic ink composition with the second liquid carrier may comprise a continuous process, for example, a continuous filtration process. In a continuous filtration process, the second liquid carrier may be simultaneously added to and removed from the liquid electrostatic ink composition, removing the first liquid carrier in the process.

In some examples, replacing the first liquid carrier in a liquid electrostatic ink composition with a second liquid carrier comprises passing a second liquid carrier through the liquid electrostatic ink composition, wherein the second liquid carrier is miscible with the first liquid carrier, removing the first liquid carrier from the liquid electrostatic ink composition.

In some examples, the mixture of the first liquid carrier and the second liquid carrier that is removed is then separated for re-use. In some examples, the first liquid carrier and the second liquid carrier are separated by distillation.

Method for Forming a Print Ready Composition

In some examples, there is provided a method for forming a print ready composition comprising dispersing a concentrated liquid electrostatic ink composition with a third liquid carrier to form a print ready liquid electrostatic ink composition. In some examples, the method for forming a print ready composition comprises dispersing a concentrated liquid electrostatic ink composition with a third liquid carrier to form a print ready liquid electrostatic ink composition, wherein the dispersing is by mixing. In some examples, the mixing may be high-shear mixing.

In some examples, the third liquid carrier may be the same as or different from the first liquid carrier. In the print ready liquid electrostatic ink composition, the third liquid carrier may be termed the first liquid carrier.

In some example, the method for forming a print ready composition comprises forming a concentrated liquid electrostatic ink composition by the method described herein and re-dispersing the concentrated liquid electrostatic ink composition with a third liquid carrier to form a print ready electrostatic ink composition. In some example, the method for forming a print ready composition comprises forming a concentrated liquid electrostatic ink composition by the method described herein and re-dispersing the concentrated liquid electrostatic ink composition with a third liquid carrier to form a print ready electrostatic ink composition, wherein the re-dispersing is by mixing, for example, high-shear mixing.

As used herein, high-shear mixing applies a shear stress of 15 kPa or more.

In some examples, mixing, for example, high-shear mixing comprises mixing at a speed of 10,000 rpm or more, for example, 11,000 rpm or more, 12,000 rpm or more, 13,000 rpm or more, 14,000 rpm or more, 15,000 rpm or more, 16,000 rpm or more, 17,000 rpm or more, 18,000 rpm or more, 19,000 rpm or more, or 20,000 rpm or more. In some examples, mixing, for example, high-shear mixing comprises mixing at a speed of 30,000 rpm or less, for example, 29,000 rpm or less, 28,000 rpm or less, 27,000 rpm or less, 26,000 rpm or less, 25,000 rpm or less, 24,000 rpm or less, 23,000 rpm or less, 22,000 rpm or less, or 21,000 rpm or less. In some examples, mixing, for example, high-shear mixing comprises mixing at a speed of 10,000 rpm to 30,000 rpm, 11,000 rpm to 29,000 rpm, 12,000 rpm to 28,000 rpm, 13,000 rpm to 27,000 rpm, 14,000 rpm to 26,000 rpm, 15,000 rpm to 25,000 rpm, 16,000 rpm to 24,000 rpm, 17,000 rpm to 23,000 rpm, 18,000 rpm to 22,000 rpm, 19,000 rpm to 21,000 rpm, or 20,000 rpm to 21,000 rpm.

In some examples, mixing, for example, high-shear mixing, occurs for 30 seconds or more, for example, 1 min or more, 1.5 min or more, 2 min or more, 2.5 min or more, 3 min or more, 3.5 min or more, 4 min or more, 4.5 min or more, 5 min or more, 5.5 min or more, 6 min or more, 6.5 min or more, 7 min or more, 7.5 min or more, 8 min or more, 8.5 min or more, 9 min or more, 9.5 min or more, or 10 min or more. In some examples, mixing, for example, high shear mixing occurs for 1 h or less, for example, 30 min or less, 20 min or less, 19.5 min or less, 19 min or less, 18.5 min or less, 18 min or less, 17.5 min or less, 17 min or less, 16.5 min or less, 16 min or less, 15.5 min or less, 15 min or less, 14.5 min or less, 14 min or less, 13.5 min or less, 13 min or less, 12.5 min or less, 12 min or less, 11.5 min or less, 11 min or less, 10.5 min or less, or 10 min or less. In some examples, mixing, for example, high-shear mixing, occurs for 30 seconds to 1 hour, for example, 1 min to 30 min, 1.5 min to 20 min, 2 min to 19.5 min, 2.5 min to 19 min, 3 min to 18.5 min, 3.5 min to 18 min, 4 min to 17.5 min, 4.5 min to 17 min, 5 min to 16.5 min, 5.5 min to 16 min, 6 min to 15.5 min, 6.5 min to 15 min, 7 min to 14.5 min, 7.5 min to 14 min, 8 min to 13.5 min, 8.5 min to 13 min, 9 min to 12.5 min, 9.5 min to 12 min, 10 min to 11.5 min, 10 min to 11 min, or 10 min to 10.5 min.

In some examples, the method for forming a print ready composition may further comprise adding a charge director.

Liquid Carrier

The first liquid carrier, second liquid carrier and third liquid carrier may be referred to herein as the liquid carrier. In some examples, the first liquid carrier and the third liquid carrier may be the same.

The liquid carrier can include or be a hydrocarbon, silicone oil, vegetable oil, etc. The liquid carrier can include, for example, an insulating, non-polar, non-aqueous liquid that can be used as a medium for chargeable particles, for example, the chargeable particles comprising the resin and, in some examples, a colorant. The liquid carrier can include compounds that have a resistivity in excess of about 10⁹ ohm-cm. The liquid carrier may have a dielectric constant below about 5, in some examples, below about 3. The liquid carrier can include hydrocarbons. The hydrocarbon can include, for example, an aliphatic hydrocarbon, an isomerized aliphatic hydrocarbon, branched chain aliphatic hydrocarbons, aromatic hydrocarbons, and combinations thereof. Examples of the liquid carrier include, for example, aliphatic hydrocarbons, isoparaffinic compounds, paraffinic compounds, dearomatized hydrocarbon compounds, and the like. In particular, the liquid carrier can include, for example, Isopar-G™, Isopar-H™ Isopar-L™, Isopar-M™, Isopar-K™, Isopar-V™, Norpar 12™, Norpar 13™, Norpar 15™, Exxol D40™, Exxol D80™, Exxol D100™, Exxol D130™, and Exxol D140™ (each sold by EXXON CORPORATION); Teclen N-16™, Teclen N-20™, Teclen N-22™, Nisseki Naphthesol L™, Nisseki Naphthesol M™, Nisseki Naphthesol H™, #0 Solvent L™, #0 Solvent M™, #0 Solvent H™, Nisseki Isosol 300™, Nisseki Isosol 400™, AF-4™, AF-5™, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™)

Second Liquid Carrier

The second liquid carrier may have a boiling point below 100° C. that is lower than the boiling point of the first liquid carrier. In some examples, the second liquid carrier may have a boiling point of less than 100° C., for example, 95° C. or less, 90° C. or less, 85° C. or less, 80° C. or less, 75° C. or less, 70° C. or less, 65° C. or less, 60° C. or less, 55° C. or less, 50° C. or less, 45° C. or less, 40° C. or less, or 35° C. or less. In some examples, the second liquid carrier may have a boiling point of 35° C. or more, 40° C. or more, 45° C. or more, 50° C. or more, 55° C. or more, 60° C. or more, 65° C. or more, 70° C. or more, 75° C. or more, 80° C. or more, 85° C. or more, 90° C. or more, or 95° C. or more. In some examples, the second liquid carrier may have a boiling point within the range of 35° C. to 100° C., for example, 40° C. to 95° C., 45° C. to 90° C., 50° C. to 85° C., 55° C. to 80° C., 60° C. to 75° C., 60° C. to 70° C., or 65° C. to 70° C. In some examples, the second liquid carrier may comprise a mixture having a boiling point range that is below 100° C. In some examples, the second liquid carrier may comprise a mixture wherein the boiling point range of the mixture is within the range of boiling points defined above.

In some examples, the second liquid carrier is any liquid miscible with the first liquid carrier having a boiling point below 100° C. that is lower than the boiling point of the first liquid carrier. In some examples, the second liquid carrier comprises a hydrocarbon. In some examples, the second liquid carrier comprises a substituted or unsubstituted hydrocarbon. In some examples, the second liquid carrier comprises an unsubstituted hydrocarbon. In some examples, the second liquid carrier comprises an aliphatic hydrocarbon, an isomerized aliphatic hydrocarbon, a branched chain aliphatic hydrocarbon, an aromatic hydrocarbon, and combinations thereof.

In some examples, the second liquid carrier comprises 5 to 8 carbon atoms. In some examples, the second liquid carrier comprises a substituted or unsubstituted hydrocarbon comprising 5 to 8 carbon atoms. In some examples, the second liquid carrier comprises an unsubstituted hydrocarbon comprising 5 to 8 carbon atoms. In some examples, the second liquid carrier is selected from 2-methylbutane (i.e., isopentane), 2,2-dimethylbutane, 2,3-dimethylbutane, pentane, 2-methylpentane, 3-methylpentane, hexane, cyclohexane, 2-methylhexane, 3-methylhexane, 2,2-dimethylpentane, 2,3-dimethylpentane, 2,4-dimethylpentane, 3,3-dimethylpentane, 3-ethylpentane, 2,2,3-trimethylbutane, heptane, 2,2,4-trimethylpentane, or mixtures thereof. In some examples, the second liquid carrier is hexane.

First Liquid Carrier

In some examples, the first liquid carrier may have a higher boiling point than the second liquid carrier. In some examples, the first liquid carrier may comprise a mixture having a boiling point range that is higher than the boiling point (or boiling point range) of the second liquid carrier. In some examples, the first liquid carrier may have a boiling point (or boiling point range) above 100° C. In some examples, the first liquid carrier may have a boiling point (or boiling point range) of 110° C. or more, for example, 120° C. or more, 130° C. or more, 140° C. or more, 150° C. or more, 160° C. or more, 170° C. or more, or 180° C. or more. In some examples, the first liquid carrier may have a boiling point (or boiling point range) of 250° C. or less, for example, 240° C. or less, 230° C. or less, 220° C. or less, 210° C. or less, or 200° C. or less. In some examples, the first carrier liquid may have a boiling point (or boiling point range) within the range of 100° C. to 250° C., for example, 110° C. to 250° C., 120° C. to 240° C., 130° C. to 230° C., 140° C. to 220° C., 150° C. to 210° C., 160° C. to 200° C., 170° C. to 200° C., or 180° C. to 200° C.

In some example, the first liquid carrier is miscible with the second liquid carrier. In some examples, the first liquid carrier comprises a hydrocarbon. In some examples, the first liquid carrier comprises an aliphatic hydrocarbon, an isomerized aliphatic hydrocarbon, branched chain aliphatic hydrocarbons, aromatic hydrocarbons, and combinations thereof.

In some examples, the first liquid carrier comprises at least 9 carbon atoms. In some examples, the first liquid carrier comprises a substituted or unsubstituted hydrocarbon comprising at least 9 carbon atoms. In some examples, the first liquid carrier comprises an unsubstituted hydrocarbon comprising at least 9 carbon atoms. In some examples, the first liquid carrier comprises a mixture of hydrocarbons having at least 9 carbon atoms. In some examples, the first liquid carrier comprises a mixture of hydrocarbons having 9 to 20 carbon atoms, for example, 10 to 14 carbon atoms, 11 to 13 carbon atoms, or 12 to 13 carbon atoms. In some examples, the first liquid carrier comprises a mixture of hydrocarbons wherein each individual hydrocarbon has a boiling point above 100° C.

In some examples, a major part of the first liquid carrier comprises at least 9 carbon atoms. In some examples, a major part of the first liquid carrier is at least 90 wt. % of the first liquid carrier, for example, at least 95 wt. %, at least 99 wt. % or about 100 wt. % of the first liquid carrier.

Liquid Electrostatic Ink Composition

In some examples, the liquid electrostatic ink composition comprises chargeable particles dispersed in a first liquid carrier.

In some examples, the chargeable particles may comprise a resin. In some examples, the chargeable particles may comprise a resin with a first liquid carrier absorbed in the resin. In some examples, the chargeable particles may comprise a resin swollen by the first liquid carrier.

In some examples, the chargeable particles comprise a resin and a colorant, such as a pigment. The pigment may impart a colour to the electrostatic ink composition, and the colour may be selected form cyan, magenta, yellow, black and white.

In some examples, chargeable particles comprise particles having or capable of developing a charge, for example in an electromagnetic field.

In some examples, the initial liquid electrostatic ink composition, that is, the liquid electrostatic ink composition before it is concentrated by the method for concentrating a liquid electrostatic ink, may comprise the first liquid carrier in an amount of up to 95 wt. %, for example, up to 90 wt. %, up to 85 wt. %, up to 80 wt. %, up to 75 wt. %, up to 70 wt. %, or up to 65 wt. %. In some examples, the initial liquid electrostatic ink composition may comprise the first liquid carrier in an amount of 50 wt. % or more, for example, 55 wt. % or more, 60 wt. % or more, 65 wt. % or more, 70 wt. % or more, 75 wt. % or more, or 80 wt. % or more. In some examples, the initial liquid electrostatic ink composition may comprise 50 wt. % to 95 wt. %, 55 wt. % to 90 wt. %, 60 wt. % to 85 wt. %, 65 wt. % to 80 wt. %, or 70 wt. % to 75 wt. %.

Resin

In some examples, the chargeable particles comprise a resin. The resin may be referred to as a thermoplastic polymer. A thermoplastic polymer is sometimes referred to as a thermoplastic resin.

In some examples, the resin may coat the colorant. The chargeable particles may include a core of colorant or colorant particles and have an outer layer of resin thereon. The colorant or colorant particles may be dispersed throughout each resin-containing particle. The outer layer of resin may coat the colorant or colorant particle partially or completely.

The resin typically includes a polymer. The resin can include, but is not limited to, a thermoplastic polymer. In some examples, the polymer of the resin may be selected from ethylene acrylic acid copolymers; ethylene methacrylic acid copolymers; ethylene vinyl acetate copolymers; copolymers of ethylene (e.g. 80 wt % to 99.9 wt %), and alkyl (e.g. C1 to C5) ester of methacrylic or acrylic acid (e.g. 0.1 wt % to 20 wt %); copolymers of ethylene (e.g. 80 wt % to 99.9 wt %), acrylic or methacrylic acid (e.g. 0.1 wt % to 20 wt %) and alkyl (e.g. C1 to C5) ester of methacrylic or acrylic acid (e.g. 0.1 wt % to 20 wt %); polyethylene; polystyrene; isotactic polypropylene (crystalline); ethylene ethyl acrylate; polyesters; polyvinyl toluene; polyamides; styrene/butadiene copolymers; epoxy resins; acrylic resins (e.g. copolymer of acrylic or methacrylic acid and at least one alkyl ester of acrylic or methacrylic acid wherein alkyl is, in some examples, from 1 to about 20 carbon atoms, such as methyl methacrylate (e.g. 50 wt % to 90 wt %)/methacrylic acid (e.g. 0 wt % to 20 wt %)/ethylhexylacrylate (e.g. 10 wt % to 50 wt %)); ethylene-acrylate terpolymers:ethylene-acrylic esters-maleic anhydride (MAH) or glycidyl methacrylate (GMA) terpolymers; ethylene-acrylic acid ionomers and combinations thereof.

The resin may comprise a polymer having acidic side groups. The polymer having acidic side groups may have an acidity of 50 mg KOH/g or more, in some examples an acidity of 60 mg KOH/g or more, in some examples an acidity of 70 mg KOH/g or more, in some examples an acidity of 80 mg KOH/g or more, in some examples an acidity of 90 mg KOH/g or more, in some examples an acidity of 100 mg KOH/g or more, in some examples an acidity of 105 mg KOH/g or more, in some examples 110 mg KOH/g or more, in some examples 115 mg KOH/g or more. The polymer having acidic side groups may have an acidity of 200 mg KOH/g or less, in some examples 190 mg or less, in some examples 180 mg or less, in some examples 130 mg KOH/g or less, in some examples 120 mg KOH/g or less. Acidity of a polymer, as measured in mg KOH/g can be measured using standard procedures known in the art, for example using the procedure described in ASTM D1386.

The resin may comprise a polymer, in some examples a polymer having acidic side groups, that has a melt flow rate of less than about 60 g/10 minutes, in some examples about 50 g/10 minutes or less, in some examples about 40 g/10 minutes or less, in some examples 30 g/10 minutes or less, in some examples 20 g/10 minutes or less, in some examples 10 g/10 minutes or less. In some examples, all polymers having acidic side groups and/or ester groups in the particles each individually have a melt flow rate of less than 90 g/10 minutes, 80 g/10 minutes or less, in some examples 70 g/10 minutes or less, in some examples 60 g/10 minutes or less.

The polymer having acidic side groups can have a melt flow rate of about 10 g/10 minutes to about 120 g/10 minutes, in some examples about 10 g/10 minutes to about 70 g/10 minutes, in some examples about 10 g/10 minutes to 40 g/10 minutes, in some examples 20 g/10 minutes to 30 g/10 minutes. The polymer having acidic side groups can have a melt flow rate of in some examples about 50 g/10 minutes to about 120 g/10 minutes, in some examples 60 g/10 minutes to about 100 g/10 minutes. The melt flow rate can be measured using standard procedures known in the art, for example as described in ASTM D1238.

The acidic side groups may be in free acid form or may be in the form of an anion and associated with one or more counterions, typically metal counterions, e.g. a metal selected from the alkali metals, such as lithium, sodium and potassium, alkali earth metals, such as magnesium or calcium, and transition metals, such as zinc. The polymer having acidic side groups can be selected from resins such as copolymers of ethylene and an ethylenically unsaturated acid of either acrylic acid or methacrylic acid; and ionomers thereof, such as methacrylic acid and ethylene-acrylic or methacrylic acid copolymers which are at least partially neutralized with metal ions (e.g. Zn, Na, Li) such as SURLYN® ionomers. The polymer comprising acidic side groups can be a copolymer of ethylene and an ethylenically unsaturated acid of either acrylic or methacrylic acid, where the ethylenically unsaturated acid of either acrylic or methacrylic acid constitute from 5 wt. % to about 25 wt. % of the copolymer, in some examples from 10 wt. % to about 20 wt. % of the copolymer.

The resin may comprise a copolymer of an alkylene monomer and a monomer having acidic side groups. In some examples, the alkylene monomer may be selected from ethylene and propylene. In some examples, the monomer having acidic side groups may be selected from methacrylic acid and acrylic acid. In some examples, the resin may comprise a copolymer of ethylene and a monomer selected from methacrylic acid and acrylic acid.

The resin may comprise two different polymers having acidic side groups. The two polymers having acidic side groups may have different acidities, which may fall within the ranges mentioned above. The resin may comprise a first polymer having acidic side groups that has an acidity of from 50 mg KOH/g to 110 mg KOH/g and a second polymer having acidic side groups that has an acidity of 110 mg KOH/g to 130 mg KOH/g.

The resin may comprise two different polymers having acidic side groups: a first polymer having acidic side groups that has a melt flow rate of about 10 g/10 minutes to about 50 g/10 minutes and an acidity of from 50 mg KOH/g to 110 mg KOH/g, and a second polymer having acidic side groups that has a melt flow rate of about 50 g/10 minutes to about 120 g/10 minutes and an acidity of 110 mg KOH/g to 130 mg KOH/g. The first and second polymers may be absent of ester groups.

The resin may comprise a copolymer of ethylene and acrylic acid and a copolymer of ethylene and methacrylic acid.

The resin may comprise two different polymers having acidic side groups: a first polymer that is a copolymer of ethylene (e.g. 92 to 85 wt %, in some examples about 89 wt %) and acrylic or methacrylic acid (e.g. 8 to 15 wt %, in some examples about 11 wt %) having a melt flow rate of 80 to 110 g/10 minutes and a second polymer that is a copolymer of ethylene (e.g. about 80 to 92 wt %, in some examples about 85 wt %) and acrylic acid (e.g. about 18 to 12 wt %, in some examples about 15 wt %), having a melt viscosity lower than that of the first polymer, the second polymer for example having a melt viscosity of 15000 poise or less, in some examples a melt viscosity of 10000 poise or less, in some examples 1000 poise or less, in some examples 100 poise or less, in some examples 50 poise or less, in some examples 10 poise or less. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

In any of the resins mentioned above, the ratio of the first polymer having acidic side groups to the second polymer having acidic side groups can be from about 10:1 to about 2:1. In another example, the ratio can be from about 6:1 to about 3:1, in some examples about 4:1.

The resin may comprise a polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; said polymer may be a polymer having acidic side groups as described herein. The resin may comprise a first polymer having a melt viscosity of 15000 poise or more, in some examples 20000 poise or more, in some examples 50000 poise or more, in some examples 70000 poise or more; and in some examples, the resin may comprise a second polymer having a melt viscosity less than the first polymer, in some examples a melt viscosity of 15000 poise or less, in some examples a melt viscosity of 10000 poise or less, in some examples 1000 poise or less, in some examples 100 poise or less, in some examples 50 poise or less, in some examples 10 poise or less. The resin may comprise a first polymer having a melt viscosity of more than 60000 poise, in some examples from 60000 poise to 100000 poise, in some examples from 65000 poise to 85000 poise; a second polymer having a melt viscosity of from 15000 poise to 40000 poise, in some examples 20000 poise to 30000 poise, and a third polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is Nucrel 960 (from DuPont), an example of the second polymer is Nucrel 699 (from DuPont), and an example of the third polymer is AC-5120 (from Honeywell). In some examples, the resin may comprise a first polymer having a melt viscosity of from 15000 poise to 40000 poise, in some examples 20000 poise to 30000 poise, and a second polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is Nucrel 699 (from DuPont), and an example of the second polymer is AC-5120 (from Honeywell). The first, second and third polymers may be polymers having acidic side groups as described herein. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

If the resin comprises a single type of resin polymer, the resin polymer (excluding any other components of the electrostatic ink composition) may have a melt viscosity of 6000 poise or more, in some examples a melt viscosity of 8000 poise or more, in some examples a melt viscosity of 10000 poise or more, in some examples a melt viscosity of 12000 poise or more. If the resin comprises a plurality of polymers all the polymers of the resin may together form a mixture (excluding any other components of the electrostatic ink composition) that has a melt viscosity of 6000 poise or more, in some examples a melt viscosity of 8000 poise or more, in some examples a melt viscosity of 10000 poise or more, in some examples a melt viscosity of 12000 poise or more. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

The resin may comprise two different polymers having acidic side groups that are selected from copolymers of ethylene and an ethylenically unsaturated acid of either methacrylic acid or acrylic acid; and ionomers thereof, such as methacrylic acid and ethylene-acrylic or methacrylic acid copolymers which are at least partially neutralized with metal ions (e.g. Zn, Na, Li) such as SURLYN® ionomers. The resin may comprise (i) a first polymer that is a copolymer of ethylene and an ethylenically unsaturated acid of either acrylic acid and methacrylic acid, wherein the ethylenically unsaturated acid of either acrylic or methacrylic acid constitutes from 8 wt % to about 16 wt % of the copolymer, in some examples 10 wt % to 16 wt % of the copolymer; and (ii) a second polymer that is a copolymer of ethylene and an ethylenically unsaturated acid of either acrylic acid and methacrylic acid, wherein the ethylenically unsaturated acid of either acrylic or methacrylic acid constitutes from 12 wt % to about 30 wt % of the copolymer, in some examples from 14 wt % to about 20 wt % of the copolymer, in some examples from 16 wt % to about 20 wt % of the copolymer in some examples from 17 wt % to 19 wt % of the copolymer.

In an example, the resin constitutes about 5 to 90%, in some examples about 5 to 80% by weight of the total solids of the electrostatic ink composition. In another example, the resin constitutes about 10 to 60% by weight of the total solids of the electrostatic ink composition. In another example, the resin constitutes about 15 to 40% by weight of the total solids of the electrostatic ink composition. In another example, the resin constitutes about 60 to 95% by weight, in some examples from 80 to 90% by weight, of the total solids of the electrostatic ink composition.

The resin may comprise a polymer having acidic side groups, as described above (which may be free of ester side groups), and a polymer having ester side groups. The polymer having ester side groups is, in some examples, a thermoplastic polymer. The polymer having ester side groups may further comprise acidic side groups. The polymer having ester side groups may be a copolymer of a monomer having ester side groups and a monomer having acidic side groups. The polymer may be a copolymer of a monomer having ester side groups, a monomer having acidic side groups, and a monomer absent of any acidic and ester side groups. The monomer having ester side groups may be a monomer selected from esterified acrylic acid or esterified methacrylic acid. The monomer having acidic side groups may be a monomer selected from acrylic or methacrylic acid. The monomer absent of any acidic and ester side groups may be an alkylene monomer, including, but not limited to, ethylene or propylene. The esterified acrylic acid or esterified methacrylic acid may, respectively, be an alkyl ester of acrylic acid or an alkyl ester of methacrylic acid. The alkyl group in the alkyl ester of acrylic or methacrylic acid may be an alkyl group having 1 to 30 carbons, in some examples 1 to 20 carbons, in some examples 1 to 10 carbons; in some examples selected from methyl, ethyl, iso-propyl, n-propyl, t-butyl, iso-butyl, n-butyl and pentyl.

The polymer having ester side groups may be a copolymer of a first monomer having ester side groups, a second monomer having acidic side groups and a third monomer which is an alkylene monomer absent of any acidic and ester side groups. The polymer having ester side groups may be a copolymer of (i) a first monomer having ester side groups selected from esterified acrylic acid or esterified methacrylic acid, in some examples an alkyl ester of acrylic or methacrylic acid, (ii) a second monomer having acidic side groups selected from acrylic or methacrylic acid and (iii) a third monomer which is an alkylene monomer selected from ethylene and propylene. The first monomer may constitute 1 to 50% by weight of the copolymer, in some examples 5 to 40% by weight, in some examples 5 to 20% by weight of the copolymer, in some examples 5 to 15% by weight of the copolymer. The second monomer may constitute 1 to 50% by weight of the copolymer, in some examples 5 to 40% by weight of the copolymer, in some examples 5 to 20% by weight of the copolymer, in some examples 5 to 15% by weight of the copolymer. In an example, the first monomer constitutes 5 to 40% by weight of the copolymer, the second monomer constitutes 5 to 40% by weight of the copolymer, and with the third monomer constituting the remaining weight of the copolymer. In an example, the first monomer constitutes 5 to 15% by weight of the copolymer, the second monomer constitutes 5 to 15% by weight of the copolymer, with the third monomer constituting the remaining weight of the copolymer. In an example, the first monomer constitutes 8 to 12% by weight of the copolymer, the second monomer constitutes 8 to 12% by weight of the copolymer, with the third monomer constituting the remaining weight of the copolymer. In an example, the first monomer constitutes about 10% by weight of the copolymer, the second monomer constitutes about 10% by weight of the copolymer, and with the third monomer constituting the remaining weight of the copolymer. The polymer having ester side groups may be selected from the Bynel® class of monomer, including Bynel 2022 and Bynel 2002, which are available from DuPont®.

The polymer having ester side groups may constitute 1% or more by weight of the total amount of the resin polymers in the resin, e.g. the total amount of the polymer or polymers having acidic side groups and polymer having ester side groups. The polymer having ester side groups may constitute 5% or more by weight of the total amount of the resin polymers in the resin, in some examples 8% or more by weight of the total amount of the resin polymers in the resin, in some examples 10% or more by weight of the total amount of the resin polymers in the resin, in some examples 15% or more by weight of the total amount of the resin polymers in the resin, in some examples 20% or more by weight of the total amount of the resin polymers in the resin, in some examples 25% or more by weight of the total amount of the resin polymers in the resin, in some examples 30% or more by weight of the total amount of the resin polymers in the resin, in some examples 35% or more by weight of the total amount of the resin polymers in the resin. The polymer having ester side groups may constitute from 5% to 50% by weight of the total amount of the resin polymers in the resin, in some examples 10% to 40% by weight of the total amount of the resin polymers in the resin, in some examples 15% to 30% by weight of the total amount of the polymers in the resin. The polymer having ester side groups may have an acidity of 50 mg KOH/g or more, in some examples an acidity of 60 mg KOH/g or more, in some examples an acidity of 70 mg KOH/g or more, in some examples an acidity of 80 mg KOH/g or more. The polymer having ester side groups may have an acidity of 100 mg KOH/g or less, in some examples 90 mg KOH/g or less. The polymer having ester side groups may have an acidity of 60 mg KOH/g to 90 mg KOH/g, in some examples 70 mg KOH/g to 80 mg KOH/g.

The polymer having ester side groups may have a melt flow rate of about 10 g/10 minutes to about 120 g/10 minutes, in some examples about 10 g/10 minutes to about 50 g/10 minutes, in some examples about 20 g/10 minutes to about 40 g/10 minutes, in some examples about 25 g/10 minutes to about 35 g/10 minutes.

In an example, the polymer or polymers of the resin can be selected from the Nucrel family of toners (e.g. Nucrel 403™, Nucrel 407™, Nucrel 609HS™, Nucrel 908HS™, Nucrel 1202HC™, Nucrel 30707™, Nucrel 1214™, Nucrel 903™, Nucrel 3990™, Nucrel 910™, Nucrel 925™, Nucrel 699™, Nucrel 599™, Nucrel 960™, Nucrel RX 76™, Nucrel 2806™, Bynell 2002, Bynell 2014, and Bynell 2020 (sold by E. I. du PONT)), the Aclyn family of toners (e.g. Aclyn 201, Aclyn 246, Aclyn 285, and Aclyn 295), AC-5120 and AC 580 (sold by Honeywell), and the Lotader family of toners (e.g. Lotader 2210, Lotader, 3430, and Lotader 8200 (sold by Arkema)).

In some examples, the resin may constitute 5% to 99% by weight of the total solids in the electrostatic ink composition, in some examples 50% to 90% by weight of the total solids of the electrostatic ink composition, in some examples 70% to 90% by weight of the total solids of the electrostatic ink composition.

Colorant

In some examples, the chargeable particles comprise a colorant. In some examples, the colorant may be a dye or pigment.

In some examples, the liquid electrostatic ink composition may be a white liquid electrostatic ink composition. In some examples, the liquid electrostatic ink composition comprises a white pigment.

The liquid electrostatic ink composition may substantially lack or lack a colorant. The liquid electrostatic ink composition may be a transparent liquid electrostatic ink composition. In some examples, the transparent liquid electrostatic ink composition does not contain any colorant, or substantially lacks colorant and thus is a colorant-free composition or substantially colorant-free composition. The transparent liquid electrostatic ink composition may otherwise be termed a colourless liquid electrostatic ink composition or a colourless varnish for liquid electrostatic printing. In some examples, substantially lacks may indicate that the transparent liquid electrostatic ink composition comprises 5 wt. % solids or less of colorant, in some examples, 3 wt. % solids or less of colorant, in some examples, 1 wt. % solids or less of colorant. “Colorant” may be a material that imparts a colour to the ink composition. As used herein, “colorant” includes pigments and dyes, such as those that impart colours, such as black, magenta, cyan, yellow and white to an ink. As used herein, “pigment” generally includes pigment colorants, magnetic particles, aluminas, silicas, and/or other ceramics or organometallics. Thus, though the present description primarily exemplifies the use of pigment colorants, the term “pigment” can be used more generally to describe not only pigment colorants, but also other pigments such as organometallics, ferrites, ceramics, and so forth.

The colorant can be any colorant compatible with the carrier liquid and useful for electrostatic printing. For example, the colorant may be present as pigment particles, or may comprise a resin as described herein and a pigment. The pigments can be any of those standardly used in the art. In some examples, the colorant is selected from a cyan pigment, a magenta pigment, a yellow pigment and a black pigment. For example, pigments by Hoechst including Permanent Yellow DHG, Permanent Yellow GR, Permanent Yellow G, Permanent Yellow NCG-71, Permanent Yellow GG, Hansa Yellow RA, Hansa Brilliant Yellow 5GX-02, Hansa Yellow X, NOVAPERM® YELLOW HR, NOVAPERM® YELLOW FGL, Hansa Brilliant Yellow 10GX, Permanent Yellow G3R-01, HOSTAPERM® YELLOW H4G, HOSTAPERM® YELLOW H3G, HOSTAPERM® ORANGE GR, HOSTAPERM® SCARLET GO, Permanent Rubine F6B; pigments by Sun Chemical including L74-1357 Yellow, L75-1331 Yellow, L75-2337 Yellow; pigments by Heubach including DALAMAR® YELLOW YT-858-D; pigments by Ciba-Geigy including CROMOPHTHAL® YELLOW 3 G, CROMOPHTHAL® YELLOW GR, CROMOPHTHAL® YELLOW 8 G, IRGAZINE® YELLOW 5GT, IRGALITE® RUBINE 4BL, MONASTRAL® MAGENTA, MONASTRAL® SCARLET, MONASTRAL® VIOLET, MONASTRAL® RED, MONASTRAL® VIOLET; pigments by BASF including LUMOGEN® LIGHT YELLOW, PALIOGEN® ORANGE, HELIOGEN® BLUE L 690 IF, HELIOGEN® BLUE TBD 7010, HELIOGEN® BLUE K 7090, HELIOGEN® BLUE L 710 IF, HELIOGEN® BLUE L 6470, HELIOGEN® GREEN K 8683, HELIOGEN® GREEN L 9140; pigments by Mobay including QUINDO® MAGENTA, INDOFAST® BRILLIANT SCARLET, QUINDO® RED 6700, QUINDO® RED 6713, INDOFAST® VIOLET; pigments by Cabot including Maroon B STERLING® NS BLACK, STERLING® NSX 76, MOGUL® L; pigments by DuPont including TIPURE® R-101; and pigments by Paul Uhlich including UHLICH® BK 8200. If the pigment is a white pigment, the pigment particle may be selected from the group consisting of TiO₂, calcium carbonate, zinc oxide, and mixtures thereof. In some examples, the white pigment particle may comprise an alumina-TiO₂ pigment.

The colorant or pigment may be present in the liquid electrostatic ink composition in an amount of from 10 wt. % to 80 wt. % of the total amount of resin and colorant, in some examples, 15 wt. % to 80 wt. %, in some examples 15 wt. % to 60 wt. %, in some examples, 15 wt. % to 50 wt. %, in some examples, 15 wt. % to 40 wt. %, in some examples, 15 wt. % to 30 wt. % of the total amount of resin and colorant. In some examples, the colorant or pigment particle may be present in the liquid electrostatic ink in an amount of at least 50 wt. % of the total amount of resin and colorant or pigment, for example at least 55 wt. % of the total amount of resin and colorant or pigment.

Charge Director

In some examples, the liquid electrostatic ink composition further includes a charge director. The charge director may be added to a liquid electrostatic ink composition in order to impart and/or maintain sufficient electrostatic charge on the ink particles. In some examples, the charge director may comprise ionic compounds, particularly metal salts of fatty acids, metal salts of sulfo-succinates, metal salts of oxyphosphates, metal salts of alkyl-benzenesulfonic acid, metal salts of aromatic carboxylic acids or sulfonic acids, as well as zwitterionic and non-ionic compounds, such as polyoxyethylated alkylamines, lecithin, polyvinylpyrrolidone, organic acid esters of polyvalent alcohols, etc. The charge director can be selected from, but is not limited to, oil-soluble petroleum sulfonates (e.g. neutral Calcium Petronate™, neutral Barium Petronate™ and basic Barium Petronate™), polybutylene succinimides (e.g. OLOA™ 1200 and Amoco 575), and glyceride salts (e.g. sodium salts of phosphated mono- and diglycerides with unsaturated and saturated acid substituents), sulfonic acid salts including, but not limited to, barium, sodium, calcium, and aluminum salts of sulfonic acid. The sulfonic acids may include, but are not limited to, alkyl sulfonic acids, aryl sulfonic acids, and sulfonic acids of alkyl succinates. The charge director can impart a negative charge or a positive charge on the resin-containing particles of an electrostatic ink composition.

The charge director may be added in order to impart and/or maintain sufficient electrostatic charge on the ink particles, which may be particles comprising the thermoplastic resin.

In some examples, the liquid electrostatic ink composition comprises a charge director comprising a simple salt. The ions constructing the simple salts are all hydrophilic. The simple salt may include a cation selected from the group consisting of Mg, Ca, Ba, NH₄, tert-butyl ammonium, Li⁺, and Al³⁺, or from any sub-group thereof. The simple salt may include an anion selected from the group consisting of SO₄²⁻, PO³⁻, NO³⁻, HPO₄²⁻, CO₃²⁻, acetate, trifluoroacetate (TFA), Cl⁻, BF₄⁻, F⁻, ClO₄⁻, and TiO₃⁴⁻ or from any sub-group thereof. The simple salt may be selected from CaCO₃, Ba₂TiO₃, Al₂(SO₄), Al(NO₃)₃, Ca₃(PO₄)₂, BaSO₄, BaHPO₄, Ba₂(PO₄)₃, CaSO₄, (NH₄)₂CO₃, (NH₄)₂SO₄, NH₄OAc, tert-butyl ammonium bromide, NH₄NO₃, LiTFA, Al₂(SO₄)₃, LiClO₄ and LiBF₄, or any sub-group thereof.

In some examples, the liquid electrostatic ink composition comprises a charge director comprising a sulfosuccinate salt of the general formula MAₙ, wherein M is a metal, n is the valence of M, and A is an ion of the general formula (I): [R¹—O—C(O)CH₂CH(SO₃)—C(O)—O—R²], wherein each of R¹ and R² is an alkyl group. In some examples each of R¹ and R² is an aliphatic alkyl group. In some examples, each of R¹ and R² independently is a C6-25 alkyl. In some examples, said aliphatic alkyl group is linear. In some examples, said aliphatic alkyl group is branched. In some examples, said aliphatic alkyl group includes a linear chain of more than 6 carbon atoms. In some examples, R¹ and R² are the same. In some examples, at least one of R¹ and R² is C₁₃H₂₇. In some examples, M is Na, K, Cs, Ca, or Ba.

In some examples, the charge director comprises at least one micelle forming salt and nanoparticles of a simple salt as described above. The simple salts are salts that do not form micelles by themselves, although they may form a core for micelles with a micelle forming salt. The sulfosuccinate salt of the general formula MAₙ is an example of a micelle forming salt. The charge director may be substantially free of an acid of the general formula HA, where A is as described above. The charge director may include micelles of said sulfosuccinate salt enclosing at least some of the nanoparticles of the simple salt. The charge director may include at least some nanoparticles of the simple salt having a size of 200 nm or less, and/or in some examples 2 nm or more.

The charge director may include one of, some of or all of (i) soya lecithin, (ii) a barium sulfonate salt, such as basic barium petronate (BBP), and (iii) an isopropyl amine sulfonate salt. Basic barium petronate is a barium sulfonate salt of a 21-26 carbon atom hydrocarbon alkyl, and can be obtained, for example, from Chemtura. An example isopropyl amine sulphonate salt is dodecyl benzene sulfonic acid isopropyl amine, which is available from Croda.

In some examples, the charge director constitutes about 0.001% to 20% by weight, in some examples 0.01% to 20% by weight, in some examples 0.01% to 10% by weight, in some examples 0.01% to 5% by weight of the total solids of a liquid electrostatic ink composition. In some examples, the charge director constitutes about 1% to 4% by weight of the total solids of the liquid electrostatic ink composition, in some examples 2% to 4% by weight of the total solids of the electrostatic ink composition.

In some examples, the charge director is present in an amount sufficient to achieve a particle conductivity of 200 pmho/cm or less, in some examples, 190 pmho/cm or less, in some examples, 180 pmho/cm or less, in some examples, 170 pmho/cm or less, in some examples, 160 pmho/cm or less, in some examples, 150 pmho/cm or less, in some examples, 140 pmho/cm or less, in some examples, 130 pmho/cm or less, in some examples, 120 pmho/cm or less, in some examples, 110 pmho/cm or less, in some examples, about 100 pmho/cm. In some examples, the charge director is present in an amount sufficient to achieve a particle conductivity of 50 pmho/cm or more, in some examples, 60 pmho/cm or more, in some examples, 70 pmho/cm or more, in some examples, 80 pmho/cm or more, in some examples, 90 pmho/cm or more, in some examples, about 100 pmho/cm. In some examples, the charge director is present in an amount sufficient to achieve a particle conductivity of 50 pmho/cm to 200 pmho/cm, in some examples, 60 pmho/cm to 190 pmho/cm, in some examples, 50 pmho/cm to 180 pmho/cm, in some examples, 60 pmho/cm to 170 pmho/cm, in some examples, 70 pmho/cm to 160 pmho/cm, in some examples, 80 pmho/cm to 150 pmho/cm, in some examples, 70 pmho/cm to 140 pmho/cm, in some examples, 80 pmho/cm to 130 pmho/cm, in some examples, 90 pmho/cm to 120 pmho/cm, in some examples, 90 pmho/cm to 110 pmho/cm, in some examples, 100 pmho/cm to 110 pmho/cm, in some examples, 90 pmho/cm to 100 pmho/cm.

In some examples, the charge director is present in an amount of from 3 mg/g to 50 mg/g, in some examples from 3 mg/g to 45 mg/g, in some examples from 10 mg/g to 40 mg/g, in some examples from 5 mg/g to 35 mg/g, in some examples, 20 mg/g to 35 mg/g, in some examples, 22 mg/g to 34 mg/g (where mg/g indicates mg per gram of solids of the liquid electrostatic ink composition).

Charge Adjuvant

In some examples, the liquid electrostatic ink composition includes a charge adjuvant. A charge adjuvant may promote charging of the particles when a charge director is present. The method as described herein may involve adding a charge adjuvant at any stage. The charge adjuvant can include, for example, barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Zn salts of stearic acid, Cu salts of stearic acid, Pb salts of stearic acid, Fe salts of stearic acid, metal carboxylates (e.g., Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmirate, Ca resinates, Co resinates, Mn resinates, Pb resinates, Zn resinates, AB diblock copolymers of 2-ethylhexyl methacrylate-co-methacrylic acid calcium and ammonium salts, copolymers of an alkyl acrylamidoglycolate alkyl ether (e.g., methyl acrylamidoglycolate methyl ether-co-vinyl acetate), or hydroxy bis(3,5-di-tert-butyl salicylic) aluminate monohydrate. In an example, the charge adjuvant is or includes aluminum di- or tristearate. In some examples, the charge adjuvant is VCA (aluminium stearate and aluminium palmitate, available from Sigma Aldrich).

The charge adjuvant may be present in an amount of about 0.1% to 5% by weight, in some examples about 0.1% to 1% by weight, in some examples about 0.3% to 0.8% by weight of the total solids of the liquid electrostatic ink composition, in some examples, about 1 wt. % to 5 wt. % of the total solids of the liquid electrostatic ink, in some examples about 1 wt. % to 3 wt. % of the total solids of the liquid electrostatic ink composition, in some examples about 1.5 wt. % to 2.5 wt. % of the total solids of the liquid electrostatic ink composition.

The charge adjuvant may be present in an amount of less than 5% by weight of total solids of the liquid electrostatic ink composition, in some examples in an amount of less than 4.5% by weight, in some examples in an amount of less than 4% by weight, in some examples in an amount of less than 3.5% by weight, in some examples in an amount of less than 3% by weight, in some examples in an amount of less than 2.5% by weight of the total solids of the liquid electrostatic ink composition.

In some examples, the liquid electrostatic ink composition further includes, e.g. as a charge adjuvant, a salt of multivalent cation and a fatty acid anion. The salt of multivalent cation and a fatty acid anion can act as a charge adjuvant. The multivalent cation may, in some examples, be a divalent or a trivalent cation. In some examples, the multivalent cation is selected from Group 2, transition metals and Group 3 and Group 4 in the Periodic Table. In some examples, the multivalent cation includes a metal selected from Ca, Sc, Ti, V, Cr, Mn, Fe, Co, Ni, Cu, Zn, Al and Pb. In some examples, the multivalent cation is Al³⁺. The fatty acid anion may be selected from a saturated or unsaturated fatty acid anion. The fatty acid anion may be selected from a C₈ to C₂₆ fatty acid anion, in some examples a C₁₄ to C₂₂ fatty acid anion, in some examples a C₁₆ to C₂₀ fatty acid anion, in some examples a C₁₇, C₁₈ or C₁₉ fatty acid anion. In some examples, the fatty acid anion is selected from a caprylic acid anion, capric acid anion, lauric acid anion, myristic acid anion, palmitic acid anion, stearic acid anion, arachidic acid anion, behenic acid anion and cerotic acid anion.

The charge adjuvant, which may, for example, be or include a salt of a multivalent cation and a fatty acid anion, may be present in an amount of 0.1 wt. % to 5 wt. % of the total solids of the liquid electrostatic ink composition, in some examples in an amount of 0.1 wt. % to 3 wt. % of the total solids of the liquid electrostatic ink composition, in some examples about 1 wt. % to 3 wt. % of the total solids of the liquid electrostatic ink composition, in some examples about 1.5 wt. % to 2.5 wt. % of the total solids of the liquid electrostatic ink composition.

Other Additives

The liquid electrostatic ink composition may include another additive or a plurality of other additives. The other additive or plurality of other additives may be added at any stage of the method. The other additive or plurality of other additives may be selected from a charge adjuvant, a wax, a surfactant, viscosity modifiers, and compatibility additives. The wax may be an incompatible wax. As used herein, “incompatible wax” may refer to a wax that is incompatible with the resin. Specifically, the wax phase separates from the resin phase upon the cooling of the resin fused mixture on a print substrate during and after the transfer of the ink film to the print substrate, e.g. from an intermediate transfer member, which may be a heated blanket. In some examples, the LEP ink composition comprises silica, which may be added, for example, to improve the durability of images produced using the LEP ink. The other additives may constitute 10 wt. % or less of the total solids of the electrostatic ink composition, in some examples 5 wt. % or less of the total solids of the electrostatic ink composition, in some examples 3 wt. % or less of the total solids of the electrostatic ink composition.

Concentrated Liquid Electrostatic Ink Composition

In another aspect, there is provided a concentrated liquid electrostatic ink composition. The concentrated liquid electrostatic ink composition may comprise: chargeable toner particles; and a liquid present in an amount of no more than 500 ppm, wherein the liquid has a boiling point below 100° C. The liquid having a boiling point below 100° C. may be referred to herein as a second liquid carrier.

In some examples, the concentrated liquid electrostatic ink composition may comprise: chargeable toner particles comprising a resin; and a liquid present in an amount of no more than 500 ppm, wherein the liquid has a boiling point below 100° C.

The concentrated liquid electrostatic ink composition may be any concentrated liquid electrostatic ink producible by the method for concentrating a liquid electrostatic ink composition.

In some examples, the liquid having a boiling point below 100° C. is present in an amount of no more than 400 ppm, for example, 300 ppm or less, 200 ppm or less, 100 ppm or less, 50 ppm or less, 40 ppm or less, 30 ppm or less, 20 ppm or less, 10 ppm or less, 9 ppm or less, 8 ppm or less, 7 ppm or less, 6 ppm or less, 5 ppm or less, 4 ppm or less, 3 ppm or less, 2 ppm or less, 1 ppm or less. In some examples, the liquid having a boiling point below 100° C. is present in an amount of 0.001 ppm or more, for example, 0.01 ppm or more, 0.02 ppm or more, 0.03 ppm or more, 0.04 ppm or more, 0.05 ppm or more. In some examples, the liquid having a boiling point below 100° C. is present in an amount of 0.01 ppm to 500 ppm, for example, 0.01 ppm to 100 ppm, 0.01 ppm to 50 ppm, 0.01 ppm to 10 ppm, 0.02 ppm to 9 ppm, 0.02 ppm to 8 ppm, 0.02 ppm to 7 ppm, 0.03 ppm to 6 ppm, 0.03 ppm to 5 ppm, 0.04 ppm to 4 ppm, 0.04 ppm to 3 ppm, 0.04 ppm to 2 ppm, 0.05 ppm to 1 ppm. In some examples, the amount of liquid having a boiling point below 100° C. will decrease overtime as the liquid having a boiling point below 100° C. evaporates. In some examples, the concentrated liquid electrostatic ink composition may comprise: chargeable toner particles; and a liquid present in an amount of no more than 5 ppm, wherein the liquid has a boiling point below 100° C.

In some examples, the concentrated liquid electrostatic ink composition may further comprise a further liquid having a boiling point above 100° C.

In some examples, the concentrated liquid electrostatic ink composition may comprise at least 65 wt. % non-volatile solids. In some examples, the concentrated liquid electrostatic ink composition may comprise at least 70 wt. % non-volatile solids, for example, at least 75 wt. % non-volatile solids, at least 80 wt. % non-volatile solids, at least 85 wt. % non-volatile solids, at least 90 wt. % non-volatile solids, at least 91 wt. % non-volatile solids, at least 92 wt. % non-volatile solids, at least 93 wt. % non-volatile solids, at least 94 wt. % non-volatile solids, at least 95 wt. % non-volatile solids, at least 96 wt. % non-volatile solids, at least 97 wt. % non-volatile solids, at least 98 wt. % non-volatile solids, or at least 99 wt. % non-volatile solids. In some examples, the concentrated liquid electrostatic ink composition may comprise 99 wt. % non-volatile solids or less, 98 wt. % non-volatile solids or less, 97 wt. % non-volatile solids or less, 96 wt. % non-volatile solids or less, 95 wt. % non-volatile solids or less, 94 wt. % non-volatile solids or less, 93 wt. % non-volatile solids or less, 92 wt. % non-volatile solids or less, 91 wt. % non-volatile solids or less, 90 wt. % non-volatile solids or less, 90 wt. % non-volatile solids or less, 85 wt. % non-volatile solids or less, 80 wt. % non-volatile solids or less, 75 wt. % non-volatile solids or less, 70 wt. % non-volatile solids or less, or 65 wt. % non-volatile solids or less. In some examples, the liquid electrostatic ink composition may comprise 65 wt. % to 100 wt. % non-volatile solids, 70 wt. % to 99 wt. % non-volatile solids, 75 wt. % to 98 wt. % non-volatile solids, 80 wt. % to 97 wt. % non-volatile solids, 85 wt. % to 96 wt. % non-volatile solids, 90 wt. % to 96 wt. % non-volatile solids, or 95 wt. % to 96 wt. % non-volatile solids.

In some examples, the concentrated liquid electrostatic ink composition may be a solid that, once diluted to a suitable non-volatile solids content forms a print ready liquid electrostatic ink composition. In some examples, the concentrated liquid electrostatic ink composition may comprise chargeable particles having a liquid absorbed therein.

Print Ready Liquid Electrostatic Ink Composition

In another aspect, there is provided a print ready liquid electrostatic ink composition. The print ready liquid electrostatic ink composition may comprise chargeable toner particles; a first liquid carrier; and a second liquid carrier, wherein the second liquid carrier has a boiling point below 100° C.; and wherein the second liquid carrier has a lower boiling point than the first liquid carrier. The print ready liquid electrostatic ink composition may comprise chargeable toner particles; a first liquid carrier; and a second liquid carrier, wherein the second liquid carrier has a boiling point below 100° C.; and wherein the second liquid carrier has a lower boiling point than the first liquid carrier.

The print ready liquid electrostatic ink composition may comprise any print ready liquid electrostatic ink composition producible by the method described herein.

In some examples, the print ready liquid electrostatic ink composition comprises a first liquid carrier having a boiling point above 100° C.

In some examples, the print ready liquid electrostatic ink composition comprises the second liquid carrier in an amount of no more than 400 ppm, for example, 300 ppm or less, 200 ppm or less, 100 ppm or less, 50 ppm or less, 40 ppm or less, 30 ppm or less, 20 ppm or less, 10 ppm or less, 9 ppm or less, 8 ppm or less, 7 ppm or less, 6 ppm or less, 5 ppm or less, 4 ppm or less, 3 ppm or less, 2 ppm or less, 1 ppm or less. In some examples, the print ready liquid electrostatic ink composition comprises the second liquid carrier in an amount of 0.001 ppm or more, for example, 0.01 ppm or more, 0.02 ppm or more, 0.03 ppm or more, 0.04 ppm or more, 0.05 ppm or more. In some examples, the print ready liquid electrostatic ink composition comprises the second liquid carrier in an amount of 0.01 ppm to 500 ppm, for example, 0.01 ppm to 100 ppm, 0.01 ppm to 50 ppm, 0.01 ppm to 10 ppm, 0.02 ppm to 9 ppm, 0.02 ppm to 8 ppm, 0.02 ppm to 7 ppm, 0.03 ppm to 6 ppm, 0.03 ppm to 5 ppm, 0.04 ppm to 4 ppm, 0.04 ppm to 3 ppm, 0.04 ppm to 2 ppm, 0.05 ppm to 1 ppm. In some examples, the amount of second liquid carrier in the print ready liquid electrostatic ink composition will decrease over time as the liquid having a boiling point below 100° C. evaporates. In some examples, the print ready liquid electrostatic ink composition comprises the second liquid carrier in an amount of no more than 1 ppm.

In some examples, the print ready liquid electrostatic ink composition comprises 0.5 wt. % non-volatile solids or more, for example, 1 wt. % non-volatile solids or more, 1.5 wt. % non-volatile solids or more, 2 wt. % non-volatile solids or more, 2.5 wt. % non-volatile solids or more, 3 wt. % non-volatile solids or more, 3.5 wt. % non-volatile solids or more, 4 wt. % non-volatile solids or more, 4.5 wt. % non-volatile solids or more, or 5 wt. % non-volatile solids or more. In some examples, the print ready liquid electrostatic ink composition comprises 10 wt. % non-volatile solids or less, 9.5 wt. % non-volatile solids or less, 9 wt. % non-volatile solids or less, 8.5 wt. % non-volatile solids or less, 8 wt. % non-volatile solids or less, 7.5 wt. % non-volatile solids or less, 7 wt. % non-volatile solids or less, 6.5 wt. % non-volatile solids or less, 6 wt. % non-volatile solids or less, 5.5 wt. % non-volatile solids or less, 5 wt. % non-volatile solids or less, 4.5 wt. % non-volatile solids or less, 4 wt. % non-volatile solids or less, 3.5 wt. % non-volatile solids or less, 3 wt. % non-volatile solids or less, 2.5 wt. % non-volatile solids or less, 2 wt. % non-volatile solids or less, 1.5 wt. % non-volatile solids or less, or 1 wt. % non-volatile solids or less. In some examples, the print ready liquid electrostatic ink composition comprises 0.5 wt. % to 10 wt. % non-volatile solids, 1 wt. % to 9.5 wt. % non-volatile solids, 1.5 wt. % to 9 wt. % non-volatile solids, 2 wt. % to 8.5 wt. % non-volatile solids, 2.5 wt. % to 8 wt. % non-volatile solids, 3 wt. % to 7.5 wt. % non-volatile solids, 0.5 wt. % to 7 wt. % non-volatile solids, 1 wt. % to 6.5 wt. % non-volatile solids, 1.5 wt. % to 6 wt. % non-volatile solids, 2 wt. % to 5.5 wt. % non-volatile solids, 2.5 wt. % to 5 wt. % non-volatile solids, 3 wt. % to 4.5 wt. % non-volatile solids, 0.5 wt. % to 4 wt. % non-volatile solids, 1 wt. % to 3.5 wt. % non-volatile solids, or 2 wt. % to 3 wt. % non-volatile solids.

In some examples, the liquid electrostatic ink composition, when printed on a substrate may be substantially free from carrier liquid. In a liquid electrostatic printing process and/or afterwards, the carrier liquid may be removed, for example, by an electrophoresis processes during printing and/or evaporation, such that substantially just solids are transferred to the substrate. Substantially free from carrier liquid may indicate that the ink printed on the substrate contains less than 5 wt. % carrier liquid, in some examples, less than 2 wt. % carrier liquid, in some examples, less than 1 wt. % carrier liquid, in some examples, less than 0.5 wt. % carrier liquid. In some examples, the ink printed on the substrate is free from carrier liquid.

### EXAMPLES

The following illustrates examples of the methods and other aspects described herein. Thus, these Examples should not be considered as limitations of the present disclosure, but are merely in place to teach how to make examples of the present disclosure.

Materials

Resins

Nucrel® 699: a copolymer of ethylene and methacrylic acid, made with nominally 11 wt. % methacrylic acid (available form DuPont).

AC-5120: a copolymer of ethylene and acrylic acid with an acrylic acid content of 15 wt. % (available from Honeywell).

Carrier Liquid

Isopar L™: an isoparaffinic oil comprising a mixture of 011-013 isoalkanes (produced by Exxon Mobil™; CAS number 64742-48-9. The distillation range for Isopar L™ is 185-198° C.

Hexane: boiling point: 68° C.

Charge Adjuvant

VCA: an aluminium stearate (available from Fisher Scientific™)

Charge Director

NCD (natural charge director): KT (natural soya lecithin in phospholipids and fatty acids), BBP (basic barium petronate, i.e., a barium sulfonate salt of a 21-26 carbon hydrocarbon alkyl, available from Cemtura™), and GT (dodecyl benzene sulfonic acid isopropyl amine, supplied by Croda™). The composition being 6.6 wt. % KT, 9.8 wt. % BBP and 3.6 wt. % GT and balance (80 wt. %) Isopar L™

Concentration of a Liquid Electrostatic Ink Composition—Batch Process 1

A 22 wt. % non-volatile solids (NVS) liquid electrostatic ink composition (ElectroInk™ 4.5, available from HP) comprising Isopar L as the liquid carrier (first liquid carrier) and chargeable particles comprising a resin (a 4:1 mixture of Nucrel™ 699 and A-C 5120), pigment (cyan) and a charge adjuvant (VCA) was provided.

The liquid electrostatic ink composition at 22 wt. % non-volatile solids (NVS) was diluted to 5.5 wt. % NVS with hexane (second liquid carrier). The diluted liquid electrostatic ink composition was stirred for 8 h before being left to settle for 12 to 15 h. The liquid (comprising a mixture of hexane and Isopar L) was removed by syringe until about 10 mm of liquid remained above the settled non-volatile solids. The diluted liquid electrostatic ink composition was then filtered under vacuum (by using filter paper and a Buchner funnel at 100 mbar) to evaporate the remaining liquid (comprising a mixture of Isopar L and hexane). During filtration, the filter cake of the partially concentrated liquid electrostatic ink composition was crumbled to improve removal of the liquid (as the filter cake was crumbled the vacuum fell to approximately 800 mbar). Additional hexane was then removed by evaporation under vacuum (in a vacuum bottle) to form the concentrated liquid electrostatic ink composition.

In some examples, the dilution, syringing, evaporation process was repeated to further increase the solids content of the concentrated liquid electrostatic ink composition.

The non-volatile solids content was measured using a Sarturious MA 150 at 130° C. and with an end point when the change in weight over 120 s was less than 5 mg.

Concentration of a Liquid Electrostatic Ink Composition—Batch Process 2

The concentration of a liquid electrostatic ink composition was performed as described for batch process 1 except that a vacuum chamber was used instead of filtration.

Concentration of a Liquid Electrostatic Ink Composition—Batch Process 3

The concentration of a liquid electrostatic ink composition was performed as described for batch process 1 except that spray drying was used instead of filtration. Spray drying was performed with an air gun at approximately 10 wt. % to 15 wt. % non-volatile solids.

Concentration of a Liquid Electrostatic Ink Composition—Continuous Process

The continuous process for concentrating a liquid electrostatic ink composition was the same as batch process 1 described above, except that rather than the steps of dilution followed by filtration, the Isopar L was removed by the continual addition and removal of hexane through filtration (continuous filtration) over a period of 1 to 10 hours.

Re-Dispersion of a Concentrated Liquid Electrostatic Ink Composition

The concentrated liquid electrostatic ink composition was added to a mixer (a Clarkson LB20ES) with Isopar L in an amount suitable to form a 12 to 20 wt. % non-volatile solids composition and mixed at a speed of 20,000 rpm to re-disperse the concentrated liquid electrostatic ink composition. The composition was then further diluted (prior to printing, in some examples, on the printing press) with Isopar L to 2 wt. % NVS.

### Example 1

A concentrated liquid electrostatic ink composition was prepared by following batch process 1 described above by adding the same weight of hexane as the weight of the initial liquid electrostatic ink composition and performing the dilution, syringing and filtration process three times. After evaporation (by vacuum assisted filtration) of the third batch of hexane added, the non-volatile solids content of the concentrated liquid electrostatic ink composition was 69 wt. %.

To produce a print ready liquid electrostatic ink composition, the re-dispersion (by mixing) was performed for 1 min. This provided a re-dispersed print ready liquid electrostatic ink composition with a median particle size of 6.01 μm and a percentage of particles with a particle size above 20 μm of 3.59% and a percentage of particles with a particle size below 1.5 μm of 3.35%.

Without wishing to be bound by theory, it is believed that the lower boiling point/high vapour pressure of the second liquid carrier allows such fast evaporation of the second liquid carrier from the liquid electrostatic ink composition that the chargeable particles do not have time to agglomerate during the evaporation process, resulting in the unaltered particle size distribution. It is also believed that the low boiling point of the second liquid carrier allows evaporation of the second liquid carrier to be performed at a temperature below that at which a phase change of the resins of the chargeable particles is caused.

### Example 2

A concentrated liquid electrostatic ink composition was prepared by the process described in Example 1 except that the amount of hexane added in each dilution was half the weight of the initial liquid electrostatic ink composition. After the concentrated liquid electrostatic ink had been produced, it was left overnight to dry further, providing a final non-volatile solids content of 76 wt. %.

To produce a print ready liquid electrostatic ink composition, the re-dispersion (by mixing) was performed for 10 min. This provided a re-dispersed print ready liquid electrostatic ink composition with a median particle size of 7.5 μm and a percentage of particles with a particle size above 20 μm of less than 6%.

### Example 3

A concentrated ink composition was prepared by the process described in Example 1 except that the amount of hexane added was half the weight of the initial liquid electrostatic ink composition. The final non-volatile solids content was 65 wt. %.

To produce a print ready liquid electrostatic ink composition, the re-dispersion was performed at 15 wt. % non-volatile solids for 3 min. This provided a re-dispersed print ready liquid electrostatic ink composition with a median particle size of 6.18 μm, a percentage of particles with a particle size above 20 μm of 6.0% and a percentage of particles with a particle size below 1.5 μm of 2.8%.

An additional portion of the concentrated liquid electrostatic ink composition was left in a sealed container for two weeks before being re-dispersed. This re-dispersion was performed at 12 wt. % non-volatile solids for 9 min to produce the print ready liquid electrostatic ink composition.

The print ready liquid electrostatic ink composition was used in a liquid electrostatic printer immediately after re-dispersion (dilution to 2 wt. % non-volatile solids occurred on the printing press). Images printed using this re-dispersed ink were of comparable quality to images printed with the reference ink composition (HP ElectroInk™ 4.5 at 22 wt. % non-volatile solids, which was also printed at 2 wt. % non-volatile solids).

### Example 4

A concentrated ink composition was prepared by following batch process 1 and performing the dilution, syringing, and filtration 5 times with the following ratio of hexane weight to weight of solids in the liquid electrostatic ink composition: 1, 1, 2, 2 and 2. The final non-volatile solids content was 88 wt. %.

To produce a print ready liquid electrostatic ink composition, the re-dispersion was performed for 5.5 min. This provided a re-dispersed print ready liquid electrostatic ink composition with a median particle size of 7.5 μm and a percentage of particles with a particle size above 20 μm of less than 6%.

### Example 5

A concentrated ink composition was prepared by following batch process 1 by using 205 g of initial liquid electrostatic ink composition and 621 g of hexane was used. The dilution, syringing, and evaporation process was only performed once. The final non-volatile solids content was 88 wt. %.

To produce a print ready liquid electrostatic ink composition, the re-dispersion was performed for 2 min. This provided a re-dispersed print ready liquid electrostatic ink composition with a median particle size of 7.5 μm and a percentage of particles with a particle size above 20 μm of less than 6%.

### Example 6

A concentrated ink composition was prepared by following batch process 1 and repeating the dilution, syringing and filtration steps twice in which the first dilution of the liquid electrostatic ink composition was to 5.5 wt. % non-volatile solids and the stirring was performed overnight. After filtration, the concentrated liquid electrostatic ink composition had a non-volatile solids content of 85 wt. %. This concentrated liquid electrostatic ink composition was diluted again with hexane (130 g of hexane for 76 g of solids) to a non-volatile solids content of 7.5 wt. % and the syringing and filtration described above was repeated to produce a final concentrated liquid electrostatic ink composition with a non-volatile solids content of 96.5 wt. %.

To produce a print ready liquid electrostatic ink composition, the re-dispersion was performed at 15 wt. % non-volatile solids for 7 min. This provided a re-dispersed print ready liquid electrostatic ink composition with a median particle size of 7.5 μm and a percentage of particles with a particle size above 20 μm of less than 6%.

### Example 7

A concentrated ink composition was prepared by following batch process 1 except that the dilution, syringing and filtration process was performed 3 times and the filtration under vacuum was used to achieve a non-volatile solids content of about 30 wt. % before the next batch of hexane was added to repeat the process.

After repeating the dilution, syringing and filtration process twice, the non-volatile solids content was 95 wt. %. After the third, and final, dilution, syringing and filtration, the non-volatile solids content was 96 wt. %.

To produce a print ready liquid electrostatic ink composition, the re-dispersion was performed for 21 min.

### Example 8

A concentrated ink composition was prepared by following batch process 1. The dilution, syringing and filtration process was performed only once. The final non-volatile solids content was 79 wt. %.

To produce a print ready liquid electrostatic ink composition, the re-dispersion was performed for 4 min.

### Example 9

A concentrated ink composition was prepared by following batch process 1 by repeating the dilution, syringing and filtration process once (each process was performed twice). The final non-volatile solids content was 89 wt. %.

To produce a print ready liquid electrostatic ink composition, the re-dispersion was performed at 15 wt. % non-volatile solids for 4 min.

### Example 10

A concentrated ink composition was prepared by following batch process 2 by using 225 g of ElectroInk 4.5 (22 wt. % NVS) was diluted with 676 g of hexane. The syringe was used to remove 460 g of the liquid (a mixture of Isopar L and hexane), which was replaced by a further 460 g of hexane. The major part of the liquid was then removed again by using a syringe, leaving approximately 10 mm of liquid above the settled non-volatile solids. Evaporation of the hexane was performed in a vacuum chamber. The final non-volatile solids content was 66 wt. %.

To produce a print ready liquid electrostatic ink composition, the re-dispersion was performed at 15 wt. % non-volatile solids for 0.5 to 1 min.

### Example 11

A concentrated ink composition was prepared by following batch process 2 by using 1 L of a mixture of hexane to produce a mixture in which the liquid is a 6:1 mixture of hexane and Isopar L to produce a mixture at 14 wt. % non-volatile solids and the dilution and syringing process was performed twice. The final non-volatile solids content was 81 wt. %, which rose to 88 wt. % after crumbling of large particles in the concentrate.

To produce a print ready liquid electrostatic ink composition, the re-dispersion was performed for 1 to 2 min.

### Example 12

A concentrated ink composition was prepared by following batch process 3 by using a liquid electrostatic ink composition at 14 wt. % non-volatile solids (367 g) and diluting with hexane (300 g) to produce a mixture in which the liquid is an 11.7:1 mixture of hexane to Isopar L. After removal of the major part of the liquid by syringe to produce an approximately 10 wt. % non-volatile solids mixture, the mixture was spray dried. The final non-volatile solids content was 95 wt. %.

### Example 13

A concentrated ink composition was prepared by following batch process 3 by using liquid electrostatic ink composition at 14 wt. % non-volatile solids (300 g) and diluting with hexane (300 g) to produce a mixture in which the liquid is a 19.5:1 ratio of hexane to Isopar L. Then 170 g of the liquid was removed by syringe and replaced with 170 g of hexane. Finally, liquid was again removed by syringe to produce an approximately 10 wt. % non-volatile solids mixture that was then spray dried. The final non-volatile solids content was 90 wt. %.

### Example 14

A concentrated ink composition was prepared by following batch process 3 by using 360 g of hexane to dilute 78 g of ElectroInk 4.5 (22 wt. % NVS). The clear liquid was then replaced with hexane before the liquid was removed to form an approximately 10 wt. % non-volatile solids mixture that was spray dried. The final non-volatile solids content was 85 wt. %.

While the method and apparatus have been described with reference to certain examples, those skilled in the art will appreciate that various modifications, changes, omissions, and substitutions can be made without departing from the spirit of the disclosure. It is intended, therefore, that the method and apparatus be limited by the scope of the following claims. Unless otherwise stated, the features of any dependent claim can be combined with the features of any of the other dependent claims and any of the independent claims.

1. A method for concentrating a liquid electrostatic ink composition, the method comprising:
replacing a first liquid carrier in a liquid electrostatic ink composition with a second liquid carrier, wherein the liquid electrostatic ink composition comprises chargeable toner particles dispersed in the first liquid carrier; and
removing the second liquid carrier to produce a concentrated liquid electrostatic ink composition,
wherein the second liquid carrier has a boiling point below 100° C. and wherein the second liquid carrier has a lower boiling point than the first liquid carrier.

2. The method according to claim 1, wherein replacing a first liquid carrier in a liquid electrostatic ink composition with a second liquid carrier comprises adding the second liquid carrier to the liquid electrostatic ink composition and removing a major part of the liquid from the liquid electrostatic ink composition, wherein the removed liquid comprises a mixture of the first liquid carrier and the second liquid carrier.

3. The method according to claim 2, wherein removing a major part of the liquid from the liquid electrostatic ink composition comprises removing a major part of the liquid by filtration, allowing the solids in the liquid electrostatic ink composition to settle and removing the liquid from the top, centrifugation or passing the ink composition between two surfaces with a potential applied between the two surfaces such that the charged solids of the liquid electrostatic ink composition are attracted to one surface and a major part of the liquid is removed on the second surface.

4. The method according to claim 1, wherein replacing a first liquid carrier in a liquid electrostatic ink composition with a second liquid carrier comprises passing a second liquid carrier through the liquid electrostatic ink composition, wherein the second liquid carrier dissolves the first liquid carrier, removing the first liquid carrier from the liquid electrostatic ink composition.

5. The method according to claim 1, wherein removing the second liquid carrier comprises evaporation of the second liquid carrier.

6. The method according to claim 1, wherein the concentrated liquid electrostatic ink composition comprises at least 70 wt. % non-volatile solids.

7. The method according to claim 2, further comprising repeating the addition of the second liquid carrier to the liquid electrostatic ink composition and the removal of a major part of the liquid from the liquid electrostatic ink composition.

8. The method according to claim 1, further comprising repeating the method for concentrating a liquid electrostatic ink composition to produce a concentrated liquid electrostatic ink composition with a higher non-volatile solids content for each iteration.

9. The method according to claim 1, wherein the first liquid carrier has a boiling point above 100° C.

10. A concentrated liquid electrostatic ink composition comprising:
chargeable toner particles comprising a resin; and
a liquid present in an amount of no more than 500 ppm, wherein the liquid has a boiling point below 100° C.

11. A concentrated liquid electrostatic ink composition according to claim 10, further comprising a further liquid having a boiling point above 100° C.

12. A concentrated liquid electrostatic ink composition according to claim 10, wherein the liquid having a boiling point below 100° C. is present in an amount of no more than 5 ppm.

13. A print ready liquid electrostatic ink composition comprising:
chargeable toner particles comprising a resin;
a first liquid carrier; and
a second liquid carrier, wherein the second liquid carrier has a boiling point below 100° C.; and wherein the second liquid carrier has a lower boiling point than the first liquid carrier.

14. The print ready liquid electrostatic ink composition according to claim 13, wherein the first liquid carrier has a boiling point above 100° C.

15. The print ready liquid electrostatic ink composition according to claim 13, wherein the second liquid carrier is present in an amount of no more than 500 ppm.
